(19) United States
(12) Patent Application Publication
(10) Pub. No.: US 2009/0016450 A1
(43) Pub. Date: Jan. 15, 2009

(54) IN-LOOP DEBLOCKING-FILTERING METHOD AND APPARATUS APPLIED TO VIDEO CODEC

(75) Inventors: Bing-Yau Wang, Hsinchu (TW); Wei-Tai Tsai, Hsinchu (TW)

Correspondence Address: WPAT, PC, 7225 BEVERLY ST., ANNANDALE, VA, 22003, US

(73) Assignee: FARADAY TECHNOLOGY CORPORATION, Hsinchu (TW)

(21) Appl. No.: 12/166,482

(22) Filed: Jul. 2, 2008

(30) Foreign Application Priority Data
Jul. 10, 2007 (TW) 096125119

(51) Int. Cl. H04N 7/26

(52) U.S. Cl. 375/240.29; 375/E07.193

(57) ABSTRACT

An in-loop deblocking-filtering method applied to a video CODEC is provided. The method includes steps of: receiving a macroblock of pixel values outputted from a motion-compensating unit; dividing the macroblock of pixel values into a plurality of block of pixel values, and executing a data-transpose procedure to the plurality of blocks of pixel values; storing the plurality of block of pixel values, which are processed by the data-transpose procedure, in a memory buffer; executing a horizontal deblocking-filtering procedure to the macroblock of pixel values, which are stored in the memory buffer, for updating a portion of the pixel values in the macroblock; executing the data-transpose procedure to the plurality of block of pixel values stored in the memory buffer; and executing a vertical deblocking-filtering procedure to the macroblock of pixel values, which are stored in the memory buffer, for updating a portion of the pixel values in the macroblock.

### FIELD OF THE INVENTION

The present invention relates to a coder-and-decoder (codec), and more particularly to an in-loop deblocking-filtering method and apparatus applied to a video codec.

### BACKGROUND OF THE INVENTION

In recent years, the digital players, TV boxes, and personal computers (PCs) have become the most widely used electronic apparatuses for playing the high-resolution moving pictures. Before displaying these high-resolution moving pictures, the audio-and-video data must be compressed and decompressed first according to some specifications of moving picture encoding-and-decoding techniques, wherein the moving picture encoding-and-decoding techniques are so called the moving picture compression-and-depression techniques.

At present, the MPEG-2, H.264, and Divx are the most well-known moving picture compression-and-depression standards. In 2003, Microsoft submitted a moving picture compression-and-depression technique (VC-1, Video Codec 1) to the SMPTE (Society of Motion Picture and Television Engineers), and then the VC-1 has been defined as an international moving picture compression-and-depression standard due to its outstanding performance in the high-resolution moving pictures.

According to the existing moving picture compression-and-decompression standards, digital image data is encoded or decoded in units of blocks. In other words, a frame of digital image data must be first divided to blocks of image data, and then these blocks of image data are respectively encoded or reproduced. However, when reproducing the blocks to form a frame of the digital image data, a blocking phenomenon is resulted in due to the boundaries between every pair of vertically or horizontally adjacent blocks may be mistakenly rendered as if there were real boundaries. In order to prevent the blocking phenomenon, a deblocking-filtering unit is needed to be implemented in the video codec.

Generally, the deblocking-filtering unit in the video decode is connected to a motion-compensating unit. The deblocking-filtering unit is used for receiving the formed frame with the blocking phenomenon from the motion-compensating unit. The deblocking-filtering unit then processes and outputs a deblocking-filtering procedure to form frame without the blocking phenomenon.

In Y, U, V color space, the pixel data ratio of Y:U:V in the frame of digital image data is 4:2:0, and for the convenience, only the pixel-Y value in the frame of digital image data will be illustrated in the explanation of the function of the deblocking-filtering unit due to the data arrangements of the pixel-U values and pixel-V values are similar to that of the pixel-Y values. FIG. 1 is a diagram showing a frame of digital image data constituted by 12 macroblocks (MB1˜MB12) of pixel-Y values, wherein each macroblock is constituted by 16×16-byte data, and each byte represents a pixel-Y value. In other words, each pixel-Y value has a size of one byte. As depicted in FIG. 1, each macroblock has a size of 256 bytes (16×16), and these 256 bytes respectively represent the Y values of 256 pixels (pixel 1˜pixel 256) of the corresponding positions. Furthermore, if a memory has a 32-byte data bus and each address in the memory can store 4-byte data. That means at least 64 continuous addresses are needed for storing one macroblock, wherein the label of the address is increasing from top to bottom, and from left to right. For example, the Y values of pixel 1 to pixel 4 are stored at the first address (Adr1); the Y values of pixel 5 to pixel 8 are stored at the second address (Adr2); and so on. Therefore, there are 64 addresses for storing the 256 pixel-Y values in each macroblock. For example, there are 16×16 bytes in the macroblock (as shown in MB6), each byte is corresponding to a pixel, and these 256 pixels are arranged from top to down, and from left to right; there are 64 continuous addresses (Adr1˜Adr64) in the macroblock (as shown in MB8), and each address can store 4 pixel-Y values.

Because the digital image data is encoded or decoded in the units of blocks, the macroblocks MB1˜MB12 of digital image data are sequentially outputted from the motion-compensating unit to the deblocking-filtering unit. Accordingly, the blocking phenomenon is resulted in the boundary between every two adjacent macroblocks. In order to prevent the blocking phenomenon, all the pixel-Y values located in the boundary between every two adjacent macroblocks must be updated by the deblocking-filtering unit, and then a frame without the blocking phenomenon can be reproduced by updating pixel-Y values. For example, in the macroblock MB6 depicted in FIG. 1, at least the Y values of pixel numbers 1 to 17, 32, 33, 48, 49, 64, 65, 80, 81, 96, 97, 112, 113, 128, 129, 144, 145, 160, 161, 176, 177, 192, 193, 208, 209, 224, 225, 240 to 256 are necessary to be recalculated and updated. Furthermore, when the deblocking-filtering unit is updating a Y value of a specific pixel, some Y values of related pixels around the specific pixel are also need to be referred and accessed.

According to the VC-1 standard, a relatively more amount of pixels are required to be recalculated and updated for preventing the blocking phenomenon. That is, an extra memory buffer is necessary to be implemented in the deblocking-filtering unit. The memory buffer not only serves to store the 256 pixel-Y values in a specific macroblock, but also stores the related pixel-Y values in the macroblocks which are around the specific macroblock when the deblocking-filtering unit executes the deblocking-filtering procedure to the specific macroblock. For example, when the deblocking-filtering unit executes the deblocking-filtering procedure to the macroblock MB6, not only the 16×16-byte pixel-Y values in the macroblock MB6 will be accessed and stored in the memory buffer, the 8×16-byte pixel-Y values in MB2, the 16×8-byte pixel-Y values in MB5, and the 8×8-byte pixel-Y values in MB1 will be also accessed and stored in the memory buffer. Accordingly a memory buffer capable of storing 24×24-byte pixel-Y values is required in the deblocking-filtering unit. After all the pixel-Y values of the macroblock MB6, which are stored in the memory buffer and necessary to be updated, are recalculated and stored back to the memory buffer again, the deblocking-filtering procedure to the macroblock MB6 is complete, and all the pixel-Y values stored in the memory buffer are then transmitted to a frame buffer. Similarly, the memory buffer is in use again by executing the deblocking-filtering procedure to the succeeding macroblock MB7, and so on. When all the macroblocks are processed by the deblocking-filtering procedure and transmitted to the frame buffer, a frame of digital image data without the blocking phenomenon is reproduced in the frame buffer.

According to the VC-1 standard, the deblocking-filtering procedure includes a horizontal deblocking-filtering procedure and a vertical deblocking-filtering procedure, wherein the horizontal deblocking-filtering procedure must be executed before the vertical deblocking-filtering procedure. FIGS. 2A to 2H are diagrams sequentially showing the deblocking-filtering procedure according to the VC-1 standard, wherein FIGS. 2A to 2D sequentially illustrate the horizontal deblocking-filtering procedure and FIGS. 2E to 2H sequentially illustrate the vertical deblocking-filtering procedure. As depicted in FIGS. 2A to 2D, the horizontal deblocking-filtering procedure includes steps of: executing the deblocking-filtering procedure to the pixels in rows R8 and R9 (the horizontal boundary of the macroblock MB6); executing the deblocking-filtering procedure to the pixels in rows R4 and R5; executing the deblocking-filtering procedure to the pixels in rows R16 and R17; and then executing the deblocking-filtering procedure to the pixels in rows R12 and R13. As depicted in FIGS. 2E to 2H, the vertical deblocking-filtering procedure includes steps of: executing the deblocking-filtering procedure to the pixels in columns C8 and C9 (the vertical boundary of the macroblock MB6); executing the deblocking-filtering procedure to the pixels in columns C4 and C5; executing the deblocking-filtering procedure to the pixels in columns C16 and C17; and then executing the deblocking-filtering procedure to the pixels in columns C12 and C13.

According to the VC-1 standard, when the deblocking-filtering unit executes the deblocking-filtering procedure for updating the Y values of a pair of adjacent pixels, say, pixel number 241 in the row R8 of the macroblock MB2 and pixel number 1 in the row R9 of the macroblock MB6 (depicted in FIG. 2A), all the four pixel numbers 193, 209, 225, and 241 in the macroblock MB2 and the four pixel numbers 1, 17, 33, and 49 in the macroblock MB6 are also needed to be referred and accessed. Similarly, when the deblocking-filtering unit executes the deblocking-filtering procedure to update the Y values of a pair of adjacent pixels, say, pixel number 144 in the column C8 of the macroblock MB1 and the pixel number 129 in the column C9 of the macroblock MB2 (depicted in FIG. 2E), all the four pixel numbers 141, 142, 143, and 144 in the macroblock MB1 and the four pixel numbers 129, 130, 131, and 132 in the macroblock MB2 are also needed to be referred and accessed.

FIG. 3 is a schematic diagram showing the circuit configuration of the conventional deblocking-filtering unit of the video codec. The deblocking-filtering unit includes: a filter 16, a multiplexer 18, and a memory buffer. The memory buffer further includes: a macroblock buffer 10, a column buffer 12, and a row buffer 14, wherein the size of the macroblock buffer 10 is 16×16 bytes, the size of the column buffer 12 is 24×8 bytes, the size of the row buffer 14 is 8×16 bytes. When the deblocking-filtering unit executes the deblocking-filtering procedure to a specific pair of adjacent pixels, first the filter 16 must read eight pixel-Y values related to the specific pair of adjacent pixels from the memory buffer by selection of the multiplexer 18; updates the Y values of the specific pair of adjacent pixels by the filter 16 according to the read eight pixel-Y values; and then stores back the updated pixel-Y values to the memory buffer. For example, when the deblocking-filtering unit executes the deblocking-filtering procedure for updating the pixel-Y values of the pair of adjacent pixels, pixel number 241 in the macroblock MB2 and pixel number 1 in the macroblock MB6 (depicted in FIG. 2A), the filter 16 firstly has to read the Y values of the four pixel numbers 241, 225, 209, and 193 in the macroblock MB2 and the Y values of the four pixel numbers 1, 17, 33, and 49 in the macroblock MB6; updates the Y values of the pair of adjacent pixel number 241 in the macroblock MB2 and the pixel number 1 in the macroblock MB6 according to the eight related pixel-Y values; and stores back the updated Y values of the pixel number 241 in the macroblcok MB2 and the pixel number 1 in the macroblock MB6 to the same addresses in the memory buffer. After all the pixel-Y values required to be updated are sequentially recalculated and stored back to the memory buffer, the all pixel-Y values in the memory buffer are transmitted to the frame buffer. Again, all the Y values related to the next macroblock are stored in the memory buffer for executing the deblocking-filtering procedure.

Furthermore, US Publication No. US2006/0013315A1, filtering method, apparatus, and medium used in audio-video codec, discloses a relatively poor performance of accessing image data when the deblocking-filtering unit executes the horizontal deblocking-filtering procedure. Because all the pixel-Y values in a macroblock are contiguously stored at addresses in the memory buffer, a poor performance of accessing image data is resulted in due to the deblocking-filtering unit must access eight different addresses when executing the horizontal deblocking-filtering procedure. For example, when the deblocking-filtering unit executes the horizontal deblocking-filtering procedure to the pair of adjacent pixels, pixel number 241 in macroblock MB2 and pixel number 1 in macroblock MB1, the deblocking-filtering unit must sequentially access the four Y values of pixel numbers 241, 225, 209, and 193 which are respectively stored at addresses Adr49, Adr53, Adr57, Adr61 of the macroblock MB2; and, the deblocking-filtering unit also must sequentially access the four Y values of pixel numbers 1, 17, 33, and 49 which are respectively stored at addresses Adr1, Adr5, Adr9, Adr13 of the macroblock MB6. Therefore, the deblocking-filtering unit has to take relatively more memory-accessing cycles to access the eight pixel-Y values. Furthermore, the image data accessing process in the horizontal deblocking-filtering procedure is different with that in the vertical deblocking-filtering procedure, it follows that the complications in the design of the control circuit of the deblocking-filtering unit. Therefore, providing a deblocking-filtering method and apparatus having an improved data accessing performance and also having a relatively simple control circuit design is the main purpose of the present invention.

### SUMMARY OF THE INVENTION

The present invention provides a deblocking-filtering method applied to a video codec, comprising steps of: receiving a macroblock of pixel values outputted from a motion-compensating unit; dividing the macroblock of pixel values into a plurality of block of pixel values, and executing a data-transpose procedure to the plurality of blocks of pixel values; storing the plurality of block of pixel values, which are processed by the data-transpose procedure, in a memory buffer; executing a horizontal deblocking-filtering procedure to the macroblock of pixel values, which are stored in the memory buffer, for updating a portion of the pixel values in the macroblock; executing the data-transpose procedure to the plurality of block of pixel values stored in the memory buffer; and, executing a vertical deblocking-filtering procedure to the macroblock of pixel values, which are stored in the memory buffer, for updating a portion of the pixel values in the macroblock.

Furthermore, the present invention provides a deblocking-filtering apparatus applied to a video codec, comprises: a memory buffer for receiving a macroblock of pixel values outputted from a motion-compensating unit, wherein the macroblock of pixel values can be divided into a plurality of block of pixel values, and the plurality of block of pixel values have been processed by a data-transpose procedure; a first input register for receiving a portion of pixel values in a first block stored in the memory buffer; a second input register for receiving a portion of pixel values in a second block stored in the memory buffer; a filter for updating one of the plurality of pixel value in the first input register and one of the plurality of pixel value in the second input register according to the plurality of pixel value in the first input register and the second input register; a first output register set for receiving the updated pixel values or un-updated pixel values stored in the first input register; a second output register set for receiving the updated pixel values or un-updated pixel values stored in the second input register; and, a data-transpose multiplexer for selectively executing the data-transpose procedure to the pixel values stored in the first output register set and the second output register set according to a data-transpose signal, and then storing the pixel values, processed by the data-transpose procedure or not processed by the data-transpose procedure, back to the memory buffer.

The present invention provides a deblocking-filtering apparatus applied to a video codec, wherein the deblocking-filtering apparatus can receive a plurality of macroblock of pixel values which are sequentially outputted from a motion-compensating unit, and each macroblock of pixel values can be divided into a plurality of block of pixel values, comprising: a memory buffer at least can be divided to a first memory buffer unit, a second memory buffer unit, a third memory buffer unit, and a fourth memory buffer unit, and each memory buffer unit can sequentially store the macroblock of pixel values, wherein the plurality of block of pixel values stored in the memory buffer units have been processed by a data-transpose procedure; and, a filter module, for executing a deblocking-filtering procedure according to the plurality of macroblcok of pixel values stored in the second memory buffer unit and the third memory buffer unit, and then storing the plurality of macroblocks of pixel values, which have been processed by the deblcoking-deblocking procedure, back to the first memory buffer unit and the second memory buffer unit; wherein when the filter module executes the deblocking-filtering procedure to the plurality of macroblcok of pixel values stored in the second memory buffer unit and the third memory buffer unit, simultaneously the fourth memory buffer unit receives another macroblock of pixel values, which has been processed by the data-transpose procedure, and simultaneously the first memory buffer unit transmits the macroblock of pixel values, which has been processed by the deblocking-filtering procedure, to a frame buffer.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a diagram showing a frame of digital image data constituted by 12 macroblocks (MB1˜MB12) of pixel-Y values;

FIGS. 2A to 2H are diagrams sequentially showing the deblocking-filtering procedure according to the VC-1 standard;

FIG. 3 is a schematic diagram showing the conventional circuit configuration of the deblocking-filtering unit of the video codec;

FIG. 4 is a diagram showing a data-transpose procedure applied to 4×4-byte data;

FIG. 5 is a diagram showing an arrangement of blocks of pixel-Y values in a memory buffer to constitute a macroblock;

FIG. 6A is a diagram showing the arrangement of the transposed pixel-Y values in the memory buffer and execution of the deblocking-filtering procedure to rows R8 and R9;

FIG. 6B is a diagram showing the arrangement of the transposed pixel-Y values in the memory buffer and execution of the deblocking-filtering procedure to rows R4 and R5;

FIG. 6C is a diagram showing the arrangement of the transposed pixel-Y values in the memory buffer and execution of the deblocking-filtering procedure to rows R16 and R17;

FIG. 6D is a diagram showing the arrangement of the transposed pixel-Y values in the memory buffer and execution of the deblocking-filtering procedure to rows R12 and R13;

FIG. 6E is a diagram showing the arrangement of the transposed pixel-Y values in the memory buffer and execution of the deblocking-filtering procedure to columns C8 and C9;

FIG. 6F is a diagram showing the arrangement of the transposed pixel-Y values in the memory buffer and execution of the deblocking-filtering procedure to columns C4 and C5;

FIG. 6G is a diagram showing the arrangement of the transposed pixel-Y values in the memory buffer and execution of the deblocking-filtering procedure to columns C16 and C17;

FIG. 6H is a diagram showing the arrangement of the transposed pixel-Y values in the memory buffer and execution of the deblocking-filtering procedure to columns C12 and C13;

FIG. 7 is a schematic diagram showing the circuit configuration of the deblocking-filtering unit of the present invention; and

FIG. 8 is a schematic diagram showing the circuit configuration of another deblocking-filtering unit of the present invention.

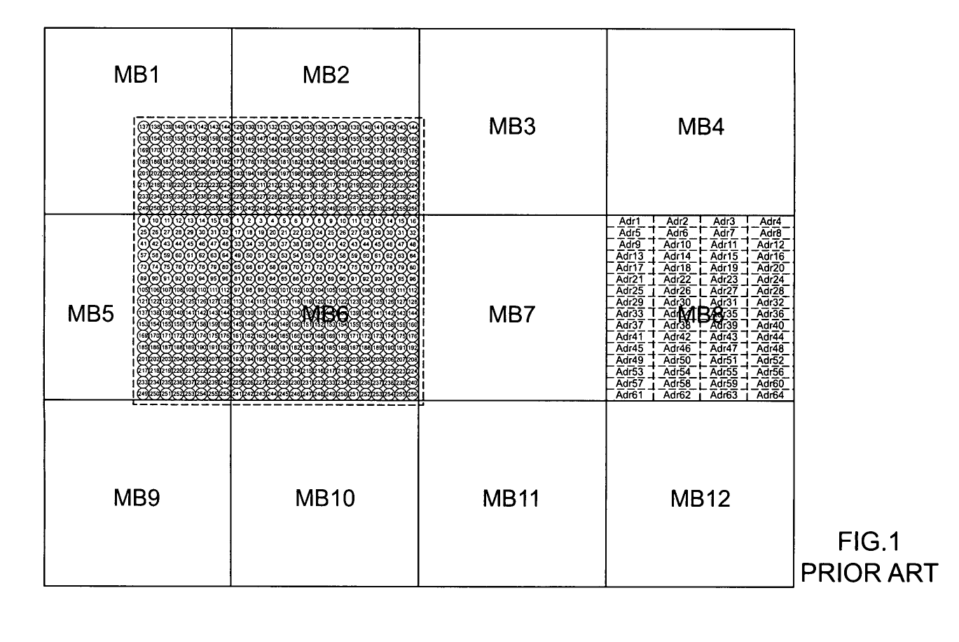

### DETAILED DESCRIPTION OF PREFERRED EMBODIMENTS

In order to prevent the problem of taking relatively more memory-accessing cycles for the prior-art deblocking-filtering unit to access eight related pixel-Y values in the memory buffer, the present invention provides a deblocking-filtering method and an apparatus having an improved image data accessing performance. Furthermore, the present invention also has a relatively simple design in the control circuit due to both the horizontal deblocking-filtering procedure and the vertical deblocking-filtering procedure have a same data processing manner.

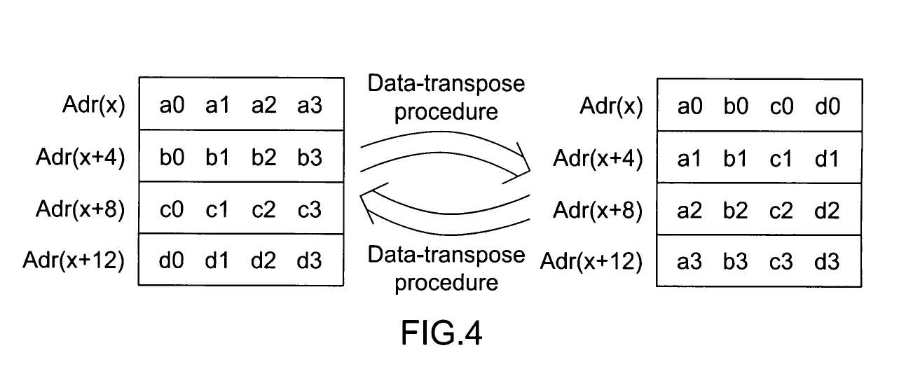

FIG. 4 is a diagram showing a data-transpose procedure applied to 4×4-byte data. The 4×4-byte data is stored at addresses Adr(x), Adr(x+4), Adr(x+8), and Adr(x+12), wherein the four-byte data a0˜a3 is stored at Adr(x); the four-byte data b0˜b3 is stored at Adr(x+4); the four-byte data c0˜c3 is stored at Adr(x+8); and the four-byte data d0˜d3 is stored at Adr(x+12). After the data-transpose procedure is executed, the four-byte data a0˜d0 is transposed to address Adr(x); the four-byte data a1˜d1 is transposed to address Adr(x+4); the four-byte data a2˜d2 is transposed to address; and the four-byte data a3˜d3 is transposed to address Adr(x+12). Similarly, after the data-transpose procedure is executed again, the four-byte data a0˜a3 is transposed back to Adr(x); the four-byte data b0˜b3 is transposed back to Adr(x+4); the four-byte data c0˜c3 is transposed back to Adr(x+8); and the four-byte data d0˜d3 is transposed back to Adr(x+12). In the present invention, the characteristic of the data-transpose procedure is used for improving the data accessing performance.

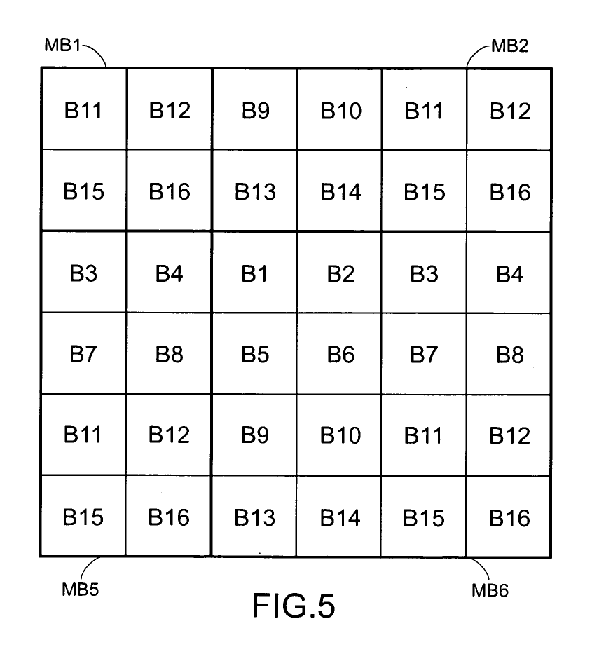

FIG. 5 is a diagram showing an arrangement of blocks of pixel-Y values in a memory buffer, where the size of each block is 4×4 bytes, each block has four addresses, and sixteen blocks B1˜B16 together constitute a macroblock. For example, the four addresses Adr1, Adr5, Adr9, Adr13 together constitute the block B1 of the macroblock MB6; the addresses Adr2, Adr6, Adr10, Adr14 together constitute the block B2 of the macroblock MB6; and so on. As depicted in FIG. 5, when the deblocking-filtering unit executes the deblocking-filtering procedure to the macroblock MB6, all the related blocks, such as the block numbers B11, B12, B15, and B16 in macroblock MB1; the block numbers B3, B4, B7, B8, B11, B12, B15, and B16 in macroblock MB5; the block numbers B9, B10, B11, B12, B13, B14, B15, and B16 in macroblock MB2, are also necessary to be accessed and stored in the memory buffer.

According to the embodiment of the present invention, before the deblocking-filtering unit of the video codec receives the macroblocks of pixel-Y values outputted from the motion-compensating unit and executes the deblocking-filtering procedure to these received macroblocks of pixels-Y values, the pixel-Y values are first processed by the data-transpose procedure in units of blocks and then stored in the memory buffer. The deblocking-filtering unit then executes the horizontal deblocking-filtering procedure to these transposed blocks of pixel-Y values.

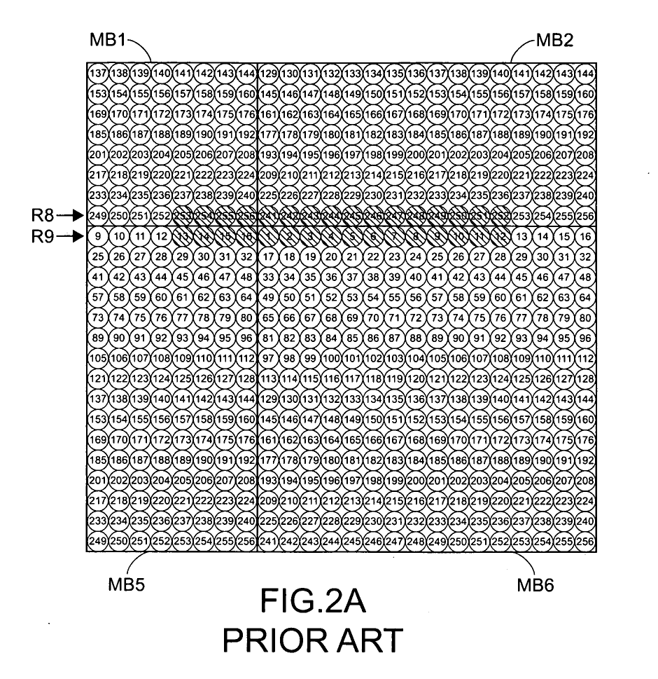

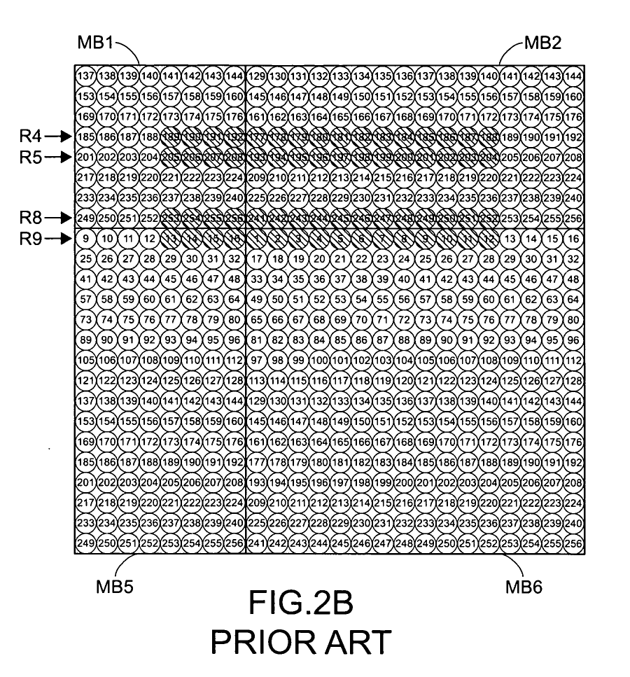

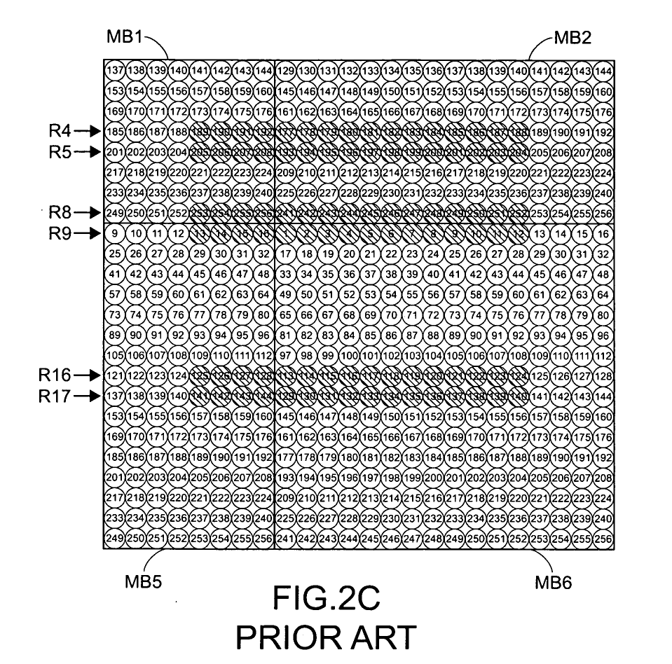

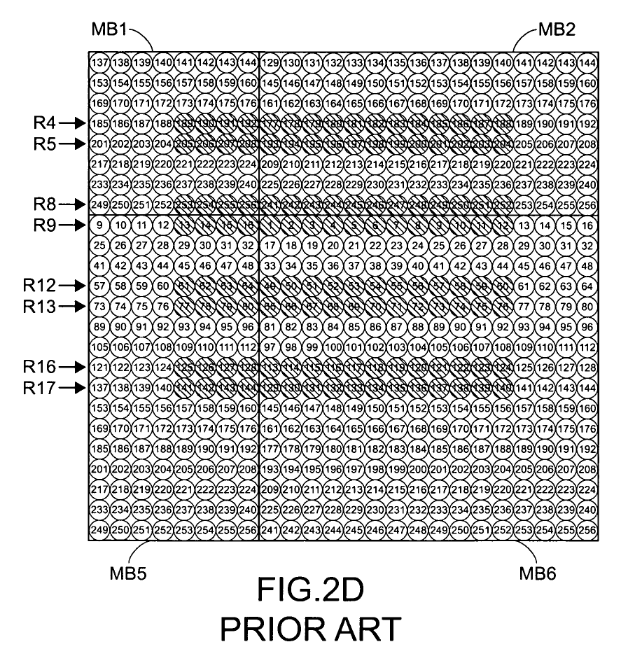

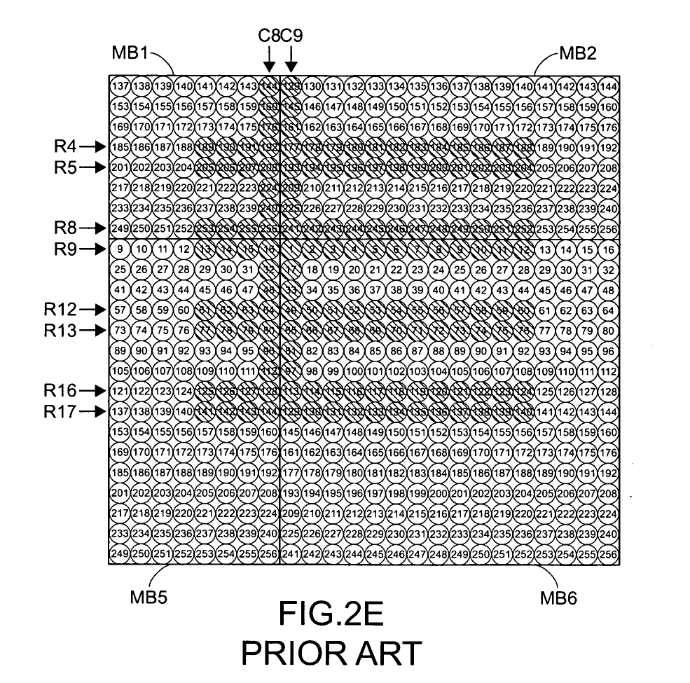

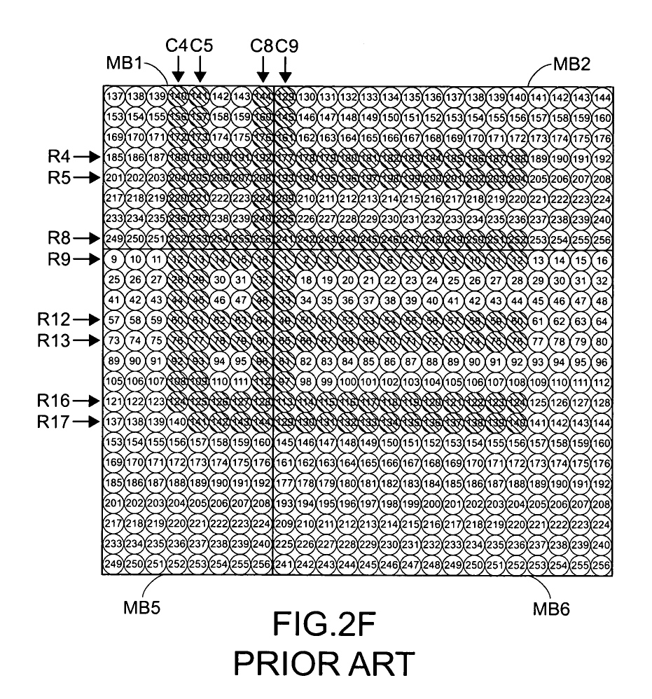

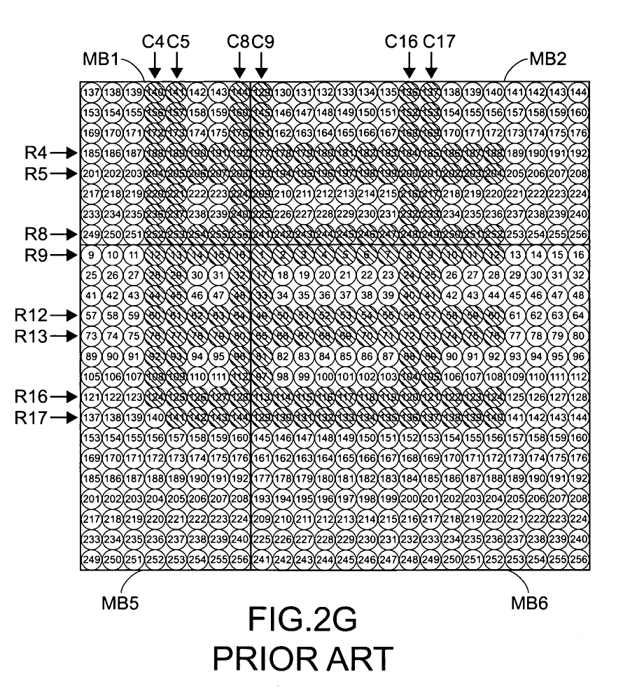

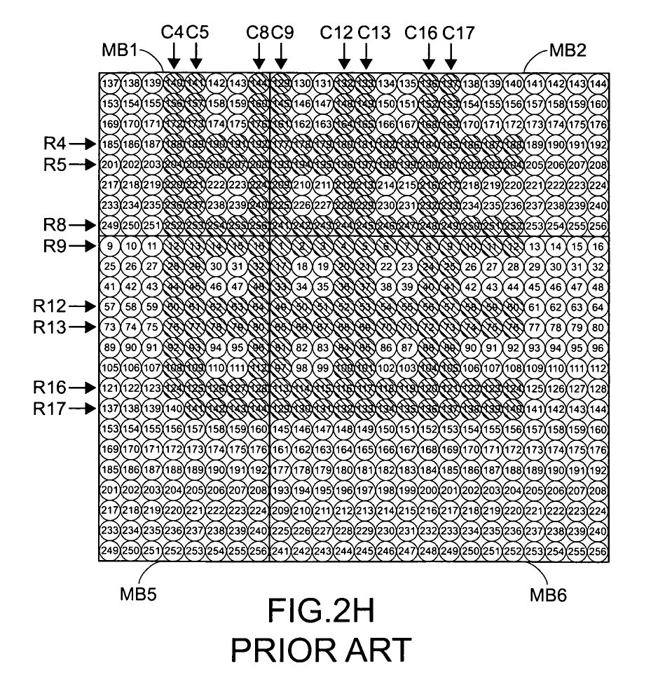

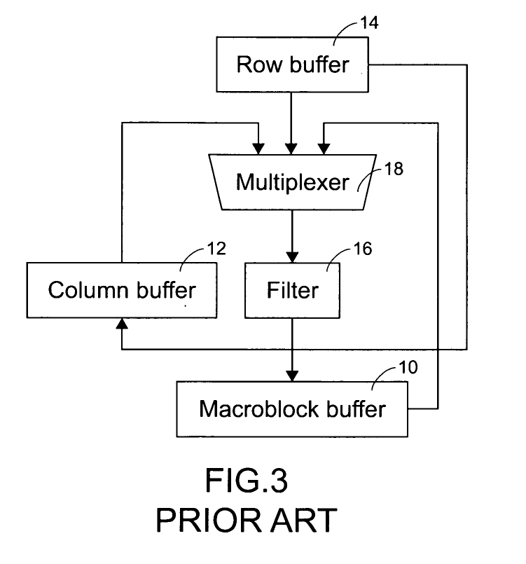

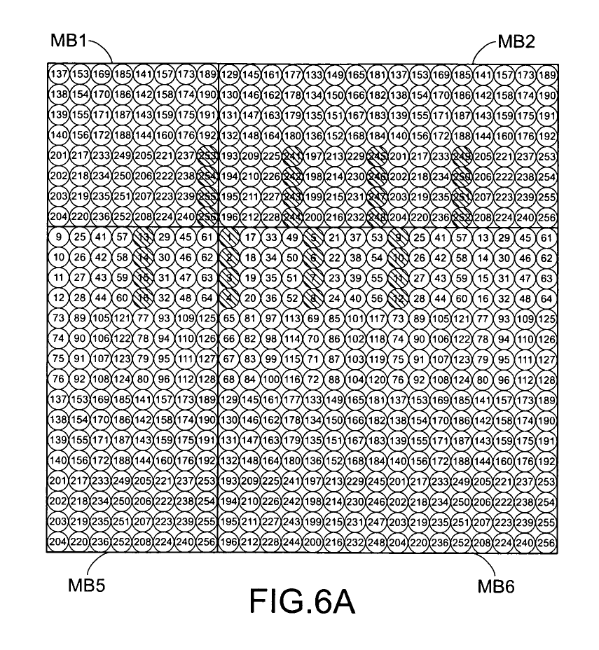

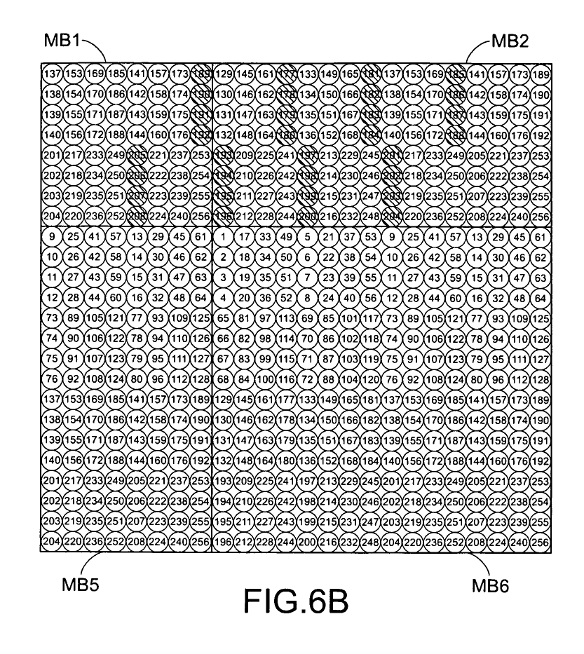

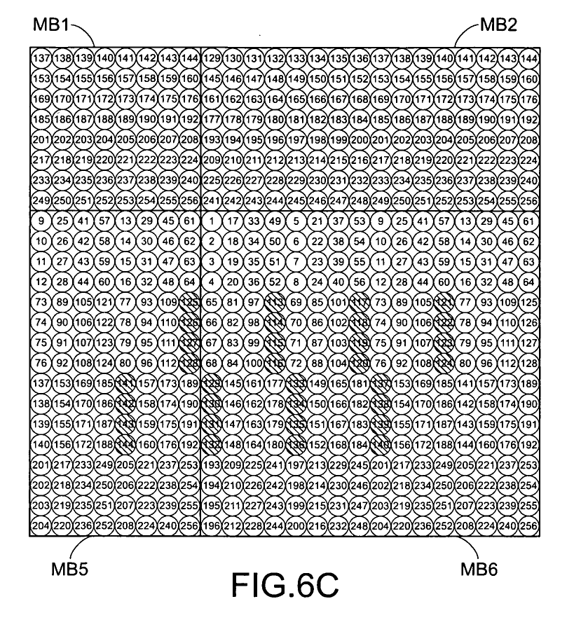

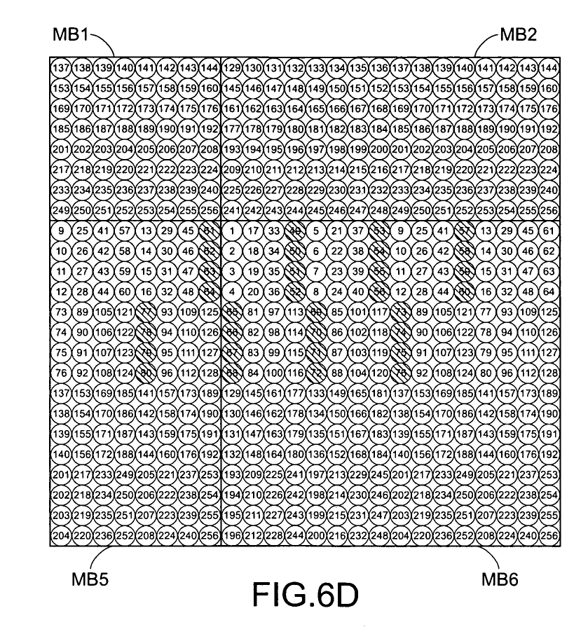

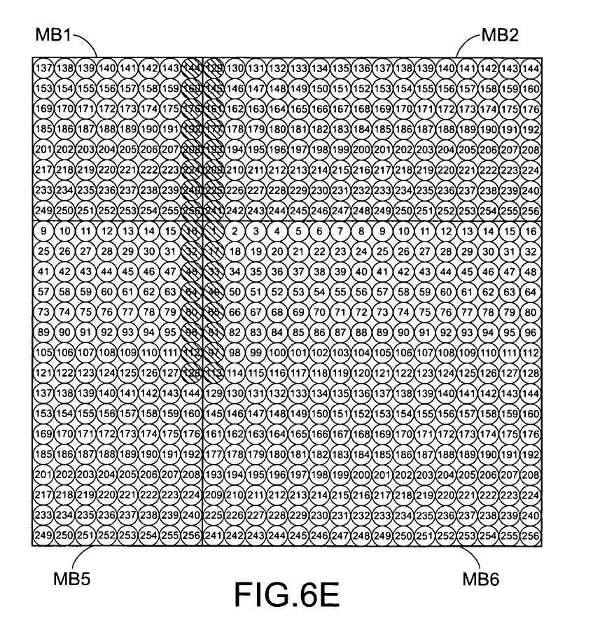

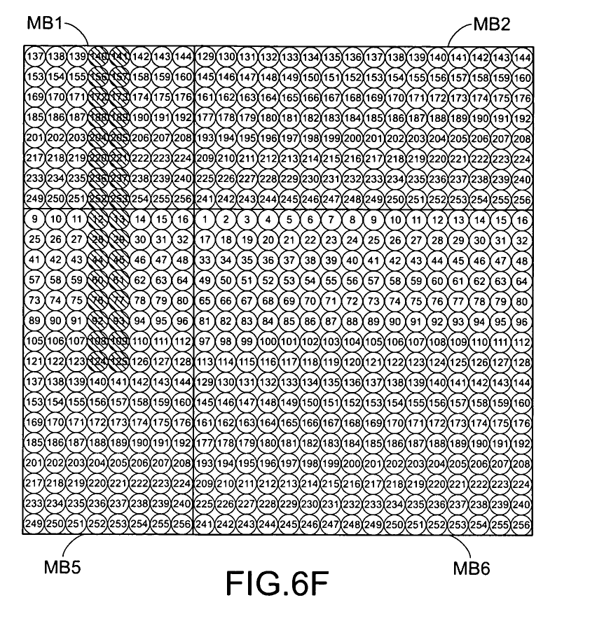

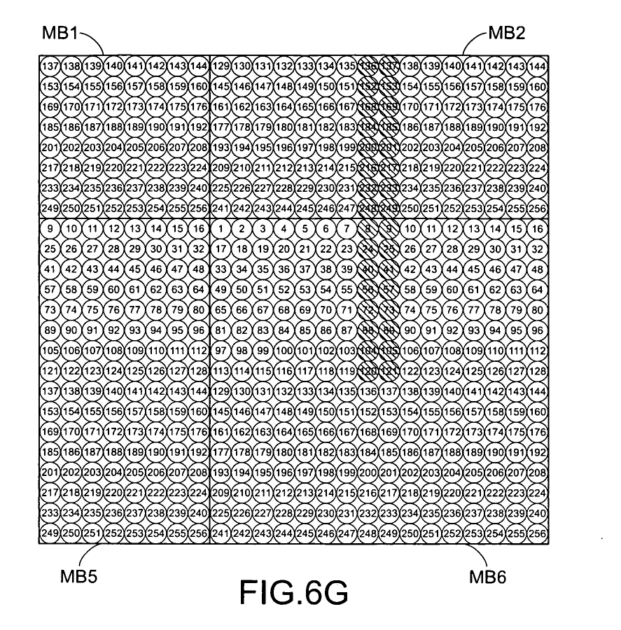

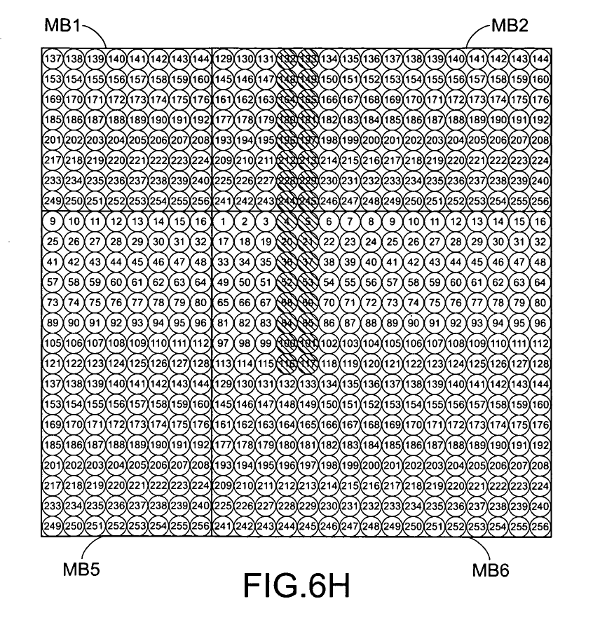

FIG. 6A is a diagram showing the arrangement of the transposed pixel-Y values in the memory buffer and execution of the horizontal deblocking-filtering procedure to rows R8 and R9. As mentioned above in FIG. 2A, when the deblocking-filtering unit is updating the Y value of the pair of the adjacent pixels, pixel number 253 in row R8 of macroblock MB1 and pixel number 13 in row R9 of macroblock MB5, the four Y values of pixel numbers 205, 221, 237, and 253 in the macroblock MB1 and the four Y values of pixel numbers 13, 29, 45, and 61 in the macroblock MB5 are also needed to be accessed and stored in the memory buffer. Because the data-transpose procedure is executed before these pixel-Y values are stored into the memory buffer, the above-mentioned eight pixel-Y values can be exactly stored at two addresses. That is, the four Y values of pixel numbers 205, 221, 237, and 253 in the macroblock MB1 can be stored at Adr52 in macroblock MB1 and the four Y values of pixel numbers 13, 29, 45, and 61 in the macroblock MB5 can be stored at Adr4 in the macroblock MB5. That means the deblocking-filtering unit only issues two accessing commands and only two memory-accessing cycles are needed to obtain the Y values of the eight pixels. After the Y values of the pair of the pixel numbers 253 and 13 are updated by these eight pixel-Y values, the two updated pixel-Y values are then stored back to the same addresses in the memory buffer. Similarly, the Y values of the rest pixels in rows R8 and R9 can be updated according to the same manner. A 32-bit bus is used for accessing the image data stored in the memory buffer in the above-mentioned example, in other words, a batch of eight pixel-Y values can be obtained after the deblocking-filtering unit issuing two accessing commands. It is understood that if a 64-bit bus is used for accessing the image data stored in the memory buffer, the batch of eight pixel-Y values can be obtained after the deblocking-filtering unit only issuing one accessing command.

After the deblocking-filtering unit completes the update of the Y values in rows R8 and R9, the deblocking-filtering unit then executes the deblocking-filtering procedure to rows R4 and R5. FIG. 6B is a diagram showing the arrangement of the transposed pixel-Y values in the memory buffer and execution of the horizontal deblocking-filtering procedure to rows R4 and R5. As mentioned above in FIG. 2B, when the deblocking-filtering unit is updating the Y values of the pair of the adjacent pixels, pixel number 189 in row R4 and pixel number 205 in row R5 of macroblock MB1, the eight Y values of pixel numbers 141, 157, 173, 189, 205, 221, 237, and 253 in the macroblock MB1 are also needed to be accessed and stored in the memory buffer; wherein the Y value of pixel number 253 in macroblock MB1 already has been updated when the deblocking-filtering procedure executed to rows R8 and R9. Because the data-transpose procedure is executed before these pixel-Y values are stored into the memory buffer, the above-mentioned eight pixel-Y values can be exactly stored at two addresses. That is, the four Y values of pixels 141, 157, 173, and 189 are stored at Adr36 and the four Y values of the pixels 205, 221, 237, and 253 are stored at Adr56 in the macroblock MB1. It follows that the eight pixel-Y values stored at Adr36 and Adr52 in macroblock MB1 can be obtained in two memory-accessing cycles after the deblocking-filtering unit issuing two accessing commands. After the Y values of the pair of the pixel numbers 189 and 205 are updated by these eight pixel-Y values, the two updated pixel-Y values are then stored back to the same addresses in the memory buffer. Similarly, the Y values of the rest pixels in rows R4 and R5 can be updated according to the same manner. Because all the pixel-Y values in macroblocks MB1 and MB2 will not be accessed and used again after the completion of the deblocking-filtering procedure executed to rows R4 and R5, the all pixel-Y values in macroblocks MB1 and MB2 can be processed by the data-transpose procedure in the units of blocks according to the embodiment of the present invention. The arrangement of the pixel-Y values in macroblocks MB1 and MB2 processed again by the data-transpose procedure is depicted in FIG. 6C.

After the deblocking-filtering unit completes the update of the Y values in rows R4 and R5, the deblocking-filtering unit then executes the deblocking-filtering procedure to rows R16 and R17. FIG. 6C is a diagram showing the arrangement of the transposed pixel-Y values in the memory buffer and execution of the horizontal deblocking-filtering procedure to rows R16 and R17. As mentioned above in FIG. 2C, when the deblocking-filtering unit is updating the Y values of the pair of the adjacent pixels, pixel number 125 in row R17 and pixel number 141 in row R18 of macroblock MB5, the eight Y values of pixel numbers 77, 93, 109, 125, 141, 157, 173, and 189 in the macroblock MB5 are also needed to be accessed and stored in the memory buffer. Because the data-transpose procedure is executed before these pixel-Y values are stored into the memory buffer, the above-mentioned eight pixel-Y values can be exactly stored at two addresses. That is, the four Y values of pixel numbers 77, 93, 109, and 125 are stored at Adr20 and the four Y values of pixel numbers 141, 157, 173, and 189 are stored at Adr36 in the macroblock MB5. That means the eight pixel-Y values stored at Adr20 and Adr36 in macroblock MB5 can be obtained in two memory-accessing cycles after the deblocking-filtering unit issuing two accessing commands. After the Y values of the pair of the pixel numbers 125 and 141 are updated by these eight pixel-Y values, the two updated pixel-Y values are then stored back to the same addresses in the memory buffer. Similarly, the Y values of the rest pixels in rows R16 and R17 can be updated according to the same manner.

After the deblocking-filtering unit completes the update of the Y values in rows R16 and R17, the deblocking-filtering unit then executes the deblocking-filtering procedure to rows R12 and R13. FIG. 6D is a diagram showing the arrangement of the transposed pixel-Y values in the memory buffer and execution of the horizontal deblocking-filtering procedure to rows R12 and R13. As mentioned above in FIG. 2D, when the deblocking-filtering unit is updating the Y values of the pair of the adjacent pixels, pixel number 61 in row R12 and pixel number 77 in row R13 of macroblock MB5, the eight Y values of pixels 13, 29, 45, 61, 77, 93, 109, and 125 in the macroblock MB5 are also needed to be accessed and stored in the memory buffer; wherein the Y value of pixel number 13 already has been updated when the deblocking-filtering procedure is executed to rows R8 and R9 and the Y value of pixel number 125 already has been updated when the deblocking-filtering procedure is executed to rows R16 and R17. Because the data-transpose procedure is executed before the pixel-Y values stored into the memory buffer, the above-mentioned eight pixel-Y values can be exactly stored at two addresses. That is, the four Y values of pixel numbers 13, 29, 45, and 61 are stored at Adr4 and the four Y values of pixel numbers 77, 93, 109, and 125 are stored at Adr20 in the macroblock MB5. That means the eight pixel-Y values stored at Adr4 and Adr20 in macroblock MB5 can be obtained in two memory-accessing cycles after the deblocking-filtering unit issuing two accessing commands. After the Y values of the pair of the pixel numbers 61 and 77 are updated by these eight pixel-Y values, the two updated pixel-Y values are then stored back to the same addresses in the memory buffer. Similarly, the Y values of the rest pixels in rows R12 and R13 can be updated according to the same manner. Because all the pixel-Y values in macroblocks MB5 and MB6 will not be accessed and used again after the completion of the deblocking-filtering procedure executed to rows R12 and R13 (horizontal deblocking-filtering procedure is complete), the all pixel-Y values in macroblocks MB5 and MB6 can be processed again by the data-transpose procedure in the units of blocks according to the embodiment of the present invention. The arrangement of the pixel-Y values in macroblocks MB5 and MB6 processed again by the data-transpose procedure is depicted in FIG. 6E.

After the horizontal deblocking-filtering procedure is complete, the deblocking-filtering unit then executes the vertical deblocking-filtering procedure. FIG. 6E is a diagram showing the arrangement of the pixel-Y values in the memory buffer and execution of the vertical deblocking-filtering procedure to columns C8 and C9. Because all the pixel-Y values in the memory buffer have been processed by the data-transpose procedure twice after the completion of the horizontal deblocking-filtering procedure, the arrangement of the Y values depicted in FIG. 6E is same as the original arrangement of the Y values depicted in FIGS. 2A˜2H. As mentioned above in FIG. 2E, when the deblocking-filtering unit is updating the Y values of the pair of the adjacent pixels, pixel number 141 in column C8 of macroblock MB1 and pixel number 129 in column C9 of macroblock MB2, the four Y values of pixel numbers 141, 142, 143, and 144 in macroblock MB1 and the four Y values of pixels 129, 130, 131, and 132 in the macroblock MB2 are also needed to be accessed and stored in the memory buffer. The above-mentioned eight pixel-Y values are exactly stored at two addresses, that is, the four Y values of pixel numbers 141, 142, 143, and 144 are stored at Adr36 of macroblock MB1 and the four Y values of pixel numbers 129, 130, 131, and 132 are stored at Adr33 of macroblock MB2. That means the eight pixel-Y values stored at Adr36 in macroblock MB1 and Adr33 in macroblock MB2 can be obtained in two memory-accessing cycles after the deblocking-filtering unit issuing two accessing commands. After the Y values of the pair of the pixel numbers 144 and 129 are updated by these eight pixel-Y values, the two updated pixel-Y values are then stored back to the same addresses in the memory buffer. Similarly, the Y values of the rest pixels in columns C8 and C9 can be updated according to the same manner.

After the deblocking-filtering unit completes the update of the Y values in columns C8 and C9, the deblocking-filtering unit then executes the deblocking-filtering procedure to columns C4 and C5. FIG. 6F is a diagram showing the arrangement of the Y values of pixels in the memory buffer and execution of the vertical deblocking-filtering procedure to columns C4 and C5. As mentioned above in FIG. 2F, when the deblocking-filtering unit is updating the Y values of the pair of the adjacent pixels, pixel number 140 in column C4 and pixel number 141 in column C5 of macroblock MB1, the eight Y values of pixel numbers 137, 138, 139, 140, 141, 142, 143, and 144 in macroblock MB1 are also needed to be accessed and stored in the memory buffer; wherein the Y value of pixel number 144 already has been updated when the deblocking-filtering procedure is executed to columns C8 and C9. The above-mentioned eight pixel-Y values are exactly stored at two addresses, that is, the four Y values of pixel numbers 137, 138, 139, and 140 are stored at Adr35 and the four Y values of the pixel numbers 141, 142, 143, and 144 are stored at Adr36 of macroblock MB1. That means the eight pixel-Y values stored at Adr35 and Adr36 in macroblock MB1 can be obtained in two memory-accessing cycles after the deblocking-filtering unit issuing two accessing commands. The two updated Y values of pixel number 140 and pixel number 141 are then stored back to the same addresses in the memory buffer. Similarly, the Y values of the rest pixels in columns C4 and C5 can be updated according to the same manner.

After the deblocking-filtering unit completes the update of the Y values in columns C4 and C5, the deblocking-filtering unit then executes the deblocking-filtering procedure to columns C16 and C17. FIG. 6G is a diagram showing the arrangement of the Y values of pixels in the memory buffer and execution of the vertical deblocking-filtering procedure to columns C16 and C17. As mentioned above in FIG. 2G, when the deblocking-filtering unit is updating the Y values of the pair of the adjacent pixels, pixel number 136 in column C16 and pixel number 137 in column C17 of macroblock MB2, the eight Y values of pixel numbers 133, 134, 135, 136, 137, 138, 139, and 140 in macroblock MB2 are also needed to be accessed and stored in the memory buffer. The above-mentioned eight pixel-Y values are exactly stored at two addresses, that is, the four Y values of pixel numbers 133, 134, 135, and 136 are stored at Adr34 and the four Y values of pixel numbers 137, 138, 139, and 140 are stored at Adr35 of macroblock MB2. That means the eight pixel-Y values stored at Adr34 and Adr35 in macroblock MB2 can be obtained in two memory-accessing cycles after the deblocking-filtering unit issuing two accessing commands. The two updated Y values of pixel number 136 and pixel number 137 are then stored back to the same addresses in the memory buffer. Similarly, the Y values of the rest pixels in columns C16 and C17 can be updated according to the same manner.

After the deblocking-filtering unit completes the update of the Y values in columns C16 and C17, the deblocking-filtering unit then executes the deblocking-filtering procedure to columns C12 and C13. FIG. 6H is a diagram showing the arrangement of the Y values of pixels in the memory buffer and execution of the vertical deblocking-filtering procedure to columns C12 and C13. As mentioned above in FIG. 2H, when the deblocking-filtering unit is updating the Y values of the pair of the adjacent pixels, pixel number 132 in column C12 and pixel number 133 in column C13 of macroblock MB2, the eight Y values of pixel numbers 129, 130, 131, 132, 133, 134, 135, 136, and 137 in macroblock MB2 are also needed to be accessed and stored in the memory buffer; wherein the Y value of pixel number 129 already has been updated when the deblocking-filtering procedure is executed to columns C8 and C9 and the Y value of pixel number 136 already has been updated when the deblocking-filtering procedure is executed to columns C16 and C17. The above-mentioned eight pixel-Y values are exactly stored at two addresses, that is, the four Y values of pixel numbers 129, 130, 131, and 132 are stored at Adr33 and the four Y values of pixel numbers 133, 134, 135, 136, and 137 are stored at Adr34 of macroblock MB2. That means the eight pixel-Y values stored at Adr33 and Adr34 in macroblock MB2 can be obtained in two memory-accessing cycles after the deblocking-filtering unit issuing two accessing commands. The two updated Y values of pixel number 132 and pixel number 133 are then stored back to the same addresses in the memory buffer. Similarly, the Y values of the rest pixels in columns C12 and C13 can be updated according to the same manner.

A 32-bit bus is used for accessing the image data stored in the memory buffer in the above-mentioned examples. In other words, a batch of eight pixel-Y values can be obtained after the deblocking-filtering unit issuing two memory-accessing commands. It is understood that if a 64-bit bus is used for accessing the image data stored in the memory buffer, a batch of eight pixel-Y values can be obtained after the deblocking-filtering unit only issuing one memory-accessing command.

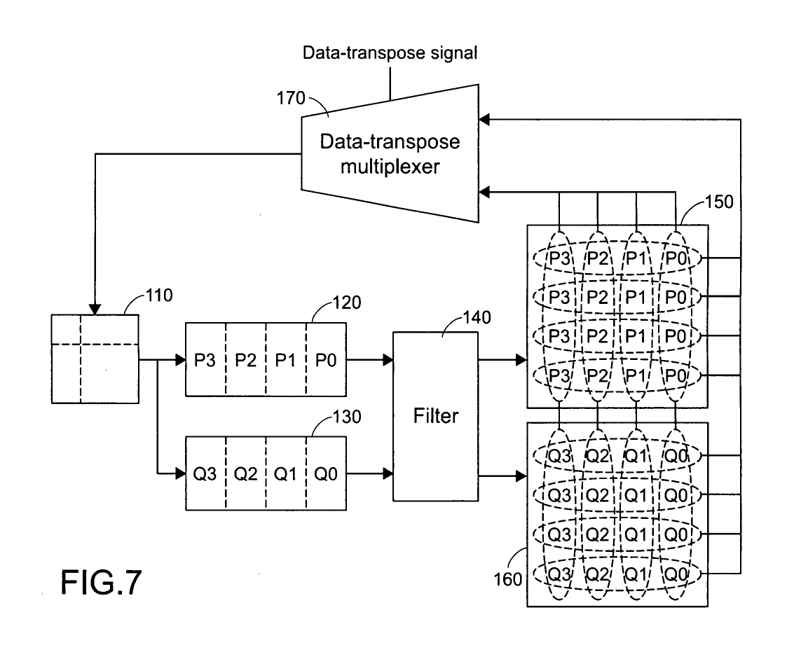

FIG. 7 is a schematic diagram showing the circuit configuration of the deblocking-filtering unit of the present invention. The deblocking-filtering unit includes: a memory buffer 110, a first input register 120, a second input register 130, a filter 140, a first output register set 150, a second output register set 160, and a data-transpose multiplexer 170. In the embodiment of the present invention, the memory buffer 110, having a size of 576 bytes (24×24 bytes), serves to store all the pixel-Y values in a specific macroblock and a portion of pixel-Y values in three macroblocks related to the specific macroblock when the deblocking-filtering unit executes the deblocking-filtering procedure to the specific macroblock. Furthermore, before the pixel-Y values in the units of macroblocks are transmitted from the motion-compensating unit to the memory buffer 110 of deblocking-filtering unit, the pixel-Y values in the units of blocks are first processed by the data-transpose procedure.

After the transposed pixel-Y values are stored in the memory buffer 110, the deblocking-filtering unit then first executes the horizontal deblocking-filtering procedure. As depicted in FIG. 7, when a pair of the adjacent pixel-Y values are needed to be updated, the eight related pixel-Y values stored in the memory buffer 110 are accessed and respectively stored at P3, P2, P1, P0 of the first input register 120 and Q3, Q2, Q1, Q0 of the second input register 130, wherein the pair of the adjacent pixel-Y values needed to be updated are stored at P0 and Q3. In the embodiment of the present invention, a 64-byte bus is used for accessing the image data stored in the memory buffer 110, and it follows that the eight pixel-Y values can be read to the first input register 120 and the second input register 130 in one memory-accessing cycle. The filter 140 then updates the pixel-Y values of the pair of the adjacent pixels stored at P0 and Q3 according to the eight related pixel-Y values. In other words, the pair of the pixel-Y values at P0 of the first input register 120 and Q3 of the second input register 130 are updated by the filter 140, and the pixel-Y values at P3, P2, P1, Q2, Q1, Q0 of the first input register 120 and the second input register 130 are remained at the same values.

In the embodiment of the present invention, the first output register set 150 and the second output register set 160 both further consist of four registers, wherein each register has a size of 32 bits. After the pair of the pixel-Y values are updated by the filter 140, the four related pixel-Y values at P3, P2, P1, P0 of the first input register 120 and the four related pixel-Y values at Q3, Q2, Q1, Q0 of the second input register 130 are outputted and correspondingly stored in one register within the first output register set 150 and one register within the second output register set 160. When the space in first output register set 150 and the second output register set 160 is full, in other words, when the filter 140 updates four pair of the adjacent pixel-Y values after issuing eight memory-accessing commands, all the pixel-Y values in the first output register set 150 and the second output register set 160 are then transmitted back to same addresses in the memory buffer 110 in the unit of blocks.

The pixel-Y values stored in the first output register set 150 and in the second output register set 160 are transmitted to the memory buffer 110 through a data-transpose multiplexer 170. The data-transpose multiplexer 170 serves to selectively receive the transposed blocks of pixel-Y values outputted from the first output register set 150 and the second output register set 160, or receive the un-transposed blocks of pixel-Y values outputted from the first output register set 150 and the second output register set 160, according to a data-transpose signal. For example, after the deblocking-filtering unit executes the horizontal deblocking-filtering procedure to rows R4 and R5, the pixel-Y values stored in the first register set 150 and the second register 160 must be first processed by the data-transpose procedure before transmitted to memory buffer 110 due to these pixel-Y values will be not accessed and used in the following deblocking-filtering procedure again.

After the horizontal deblocking-filtering procedure is complete, the deblocking-filtering unit then executes the vertical deblocking-filtering procedure. It is understood that the vertical deblocking-filtering procedure is executed according to the same manner in the horizontal deblocking-filtering procedure.

When the deblocking-filtering procedure to a specific macroblock is complete, all the pixel-Y values in the memory buffer 110 are transmitted to the frame buffer and the pixel-Y values in the succeeding macroblock are read into the memory buffer 110. For example, when the deblocking-filtering procedure to macroblock MB6 is complete, the pixel-Y values in macroblock MB7, and a portion pixel-Y values in three related macroblocks MB6, MB2, MB3 are then read into the memory buffer 110 for executing the deblocking-filtering procedure.

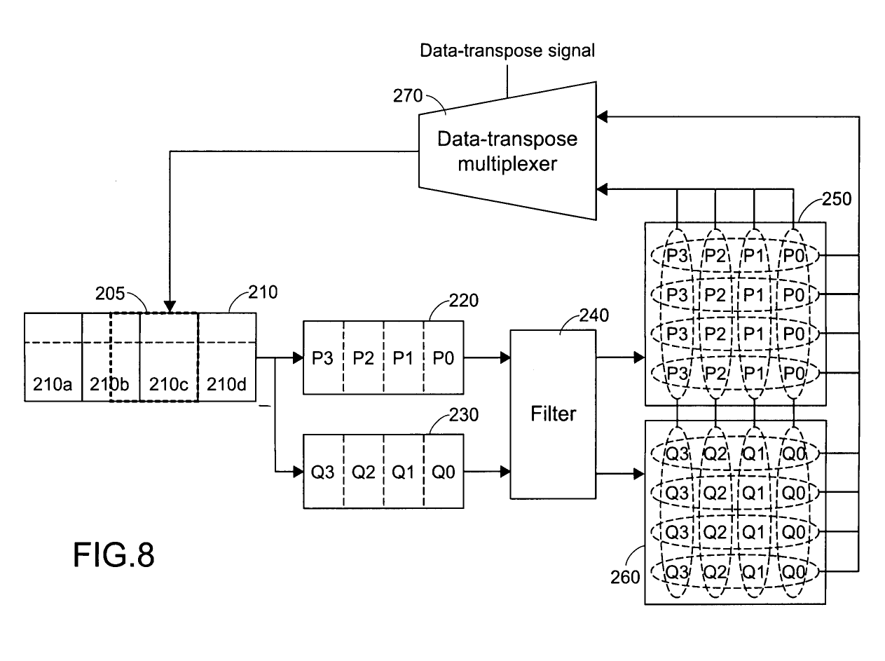

For enhancing the performance of the deblocking-filtering unit depicted in FIG. 7, another deblocking-filtering unit of the present invention is disclosed and depicted in FIG. 8. The deblocking-filtering unit consists of: a memory buffer 210, a first input register 220, a second input register 230, a filter 240, a first output register set 250, a second output register set 260, and a data-transpose multiplexer 270. In the embodiment, the memory buffer 210 further includes four memory buffer units 210a, 210b, 210c, and 210d, where each memory buffer unit has a size of 384 bytes (24×16 bytes).

Assuming the pixel-Y values of MB5 are stored in the lower portion of the memory buffer unit 210b, the pixel-Y values of MB6 are stored in the lower portion of memory buffer unit 210c, a portion of pixel-Y values of MB1 are stored in the upper portion of memory buffer unit 210b, a portion of pixel-Y values of MB2 are stored in the upper portion of memory buffer unit 210c. When the deblocking-filtering unit executes the deblocking-filtering procedure to MB6, all the pixel-Y values in memory buffer unit 210c and a portion of pixel-Y values in memory buffer unit 210b will be referred and accessed, therefore, the memory buffer unit 210c and the portion of the memory buffer unit 210b are together defined as a memory space 205, wherein the memory space 205 has a size of 576 bytes (24×24). For increasing the performance of the deblocking-filtering unit depicted in FIG. 8, when the deblocking-filtering unit is executing the deblocking-filtering procedure to the macroblock MB6, simultaneously the pixel-Y values in macroblock MB7, which are processed by the data-transpose procedure, are transmitted from the motion-compensating unit to the memory buffer unit 210d, and simultaneously the pixel-Y values of MB4 in memory buffer unit 210a, which are processed by the deblocking-filtering procedure, are transmitted to the frame buffer.

When the deblocking-filtering procedure executed to MB6 is complete, the storing of the pixel-Y values in MB7 to the memory buffer unit 210d and the transmitting of the pixel-Y values of MB4 in memory buffer unit 210a to the frame buffer are also complete. The deblocking-filtering unit then starts to execute the deblocking-filtering procedure to the macroblock MB7, and all the pixel-Y values in memory buffer unit 210d and a portion of pixel-Y values in memory buffer unit 210c will be referred and accessed, wherein the memory buffer unit 210d and the portion of the memory buffer unit 210bc together have a size of 576 bytes (24×24). At this step, the memory space has a right shift by one memory buffer unit. When the deblocking-filtering unit is executing the deblocking-filtering procedure to the macroblock MB7, simultaneously the pixel-Y values in macroblock MB8, which are processed by the data-transpose procedure, are transmitted from the motion-compensating unit to the memory buffer unit 210a, and simultaneously the pixel-Y values of MB5 in memory buffer unit 210b, which are processed by the deblocking-filtering procedure, are transmitted to the frame buffer.

In other words, the memory buffer 210 functions as a ring buffer. When the deblocking-filtering unit is executing the deblocking-filtering procedure to a specific macroblock, two out of the four memory buffer units in the memory buffer 210 are used for constituting the memory space 205, one out of the four memory buffer units is used for storing the pixel-Y values of the succeeding macroblock, and one out of the four memory buffer units is used for transmitting the pixel-Y values of a macroblock, which are processed by the deblocking-blocking procedure, to the frame buffer.

The memory buffer 110 (or 210) in the deblocking-filtering unit of the present invention can be constituted by two 32-bit memory modules A and B (not shown), and each two adjacent blocks of pixel-Y values can be individually stored in memory modules A and B. By using FIG. 5 as an example, assuming the block B16 in macroblock MB1 is stored in memory module A, then the block B13 in macroblock MB2, which is adjacent to block B16 in macroblock MB1, is stored in memory module B; the block B1 in macroblock MB6, which is adjacent to the block B13 in macroblock MB2, is stored in memory module A; the block B4 in macroblock MB5, which is adjacent to the block B16 in macroblock MB1 and the block B1 in macroblock MB6, is stored in memory module B. Through the interlacing arrangement of the storing blocks, a batch of fours related pixel-Y values can be accessed from the memory module A and another batch of fours related pixel-Y values can be accessed from the memory module B simultaneously by a 64-bit bus in one memory-accessing cycle. For example, when the deblocking-filtering unit is executing the deblocking-filtering procedure to rows R8 and R9 as depicted in FIG. 6A, the four Y values of pixels 205, 221, 237, 253 in MB1, which are stored in memory module A, and the four Y values of pixels 13, 29, 45, 61 in MB5, which are stored in memory module B, can be simultaneously accessed in one memory-accessing cycle. In other words, first the data stored in the memory module A is transmitted to the filter through a R8-input terminal for, and the data stored in the memory module B is transmitted to the filter through a R9-input terminal; after processed by the deblocking-filtering procedure, the data, which is inputted through the R8-input terminal, is then transmitted back to the memory module A through the R8-output terminal, and the data, which is inputted through the R9-input terminal, is then transmitted back to the memory module B through the R9-output terminal. Similarly, the four Y values of pixels 193, 209, 225, 241 in MB2 can be accessed from memory module B and the four Y values of pixels 1, 17, 33, 49 in MB6 can be accessed from memory module A in one memory-accessing cycle. However, because the four pixel-Y values in R8 are stored in memory module B and the four pixel-Y values in R9 are stored in memory module A, the data in the memory module B must be interlace-transmitted to the filter through the R8-input terminal, and the data in the memory module A must be interlace-transmitted to the filter through the R9-input terminal for the deblocking-filter procedure. Moreover, after the deblocking-filtering procedure, the data, which is inputted from R8-input terminal, is then interlace-transmitted back to memory module B through the R8-output terminal, and the data, which is inputted from R9-input terminal, is then interlace-transmitted back to memory module A through the R9-output terminal. In the embodiment of the present, an interlace-controlling mechanism, for controlling the data interlace-transmitted between the memory modules A/B and the filter, can be implemented in the input terminals and the output terminals of the filter.

Because the image data ratio of Y, U, V in color space is 4:2:0, it is obviously that pixel-U values and the pixel-V values can be processed by the deblocking-filtering procedure same as mentioned above after a modulation of the size of the memory buffer.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A deblocking-filtering method applied to a video codec, comprising steps of:
receiving a macroblock of pixel values outputted from a motion-compensating unit;
dividing the macroblock of pixel values into a plurality of block of pixel values, and executing a data-transpose procedure to the plurality of blocks of pixel values;
storing the plurality of block of pixel values, which are processed by the data-transpose procedure, in a memory buffer;
executing a horizontal deblocking-filtering procedure to the macroblock of pixel values, which are stored in the memory buffer, for updating a portion of the pixel values in the macroblock;
executing the data-transpose procedure to the plurality of block of pixel values stored in the memory buffer; and
executing a vertical deblocking-filtering procedure to the macroblock of pixel values, which are stored in the memory buffer, for updating a portion of the pixel values in the macroblock.

2. The method according to claim 1, further comprises a step of transmitting the macroblock of pixel values stored in the memory buffer to a frame buffer after a completion of the horizontal deblocking-filtering procedure and the vertical deblocking-filtering procedure.

3. The method according to claim 1, wherein each block, having a size of 4×4 bytes, comprises four addresses, a first address is for bits a0˜a3, a second address is for bits b0˜b3, a third address is for bits c0˜c3, and a fourth address is for bits d0˜d3.

4. The method according to claim 3, wherein the data-transpose procedure is transposing the first address for bits a0˜d0 to, the second address for bits a1˜d1, the third address for bits a2˜d2, and the fourth address for bits a3˜d3.

5. The method according to claim 3, wherein one cycle of the horizontal deblocking-filtering procedure requires to access one address of 4-bit data from two blocks of pixel values.

6. The method according to claim 3, wherein one cycle of the vertical deblocking-filtering procedure requires to access one address 4-bit data from two blocks of pixel values.

7. The method according to claim 1, wherein the macroblock of pixel values includes a plurality of pixel-Y value, a plurality of pixel-U value, or a plurality of pixel-V value.

8. A deblocking-filtering apparatus applied to a video codec, comprises:
a memory buffer for receiving a macroblock of pixel values outputted from a motion-compensating unit, wherein the macroblock of pixel values can be divided into a plurality of block of pixel values, and the plurality of block of pixel values have been processed by a data-transpose procedure;
a first input register for receiving a portion of pixel values in a first block stored in the memory buffer;
a second input register for receiving a portion of pixel values in a second block stored in the memory buffer;
a filter for updating one of the plurality of pixel value in the first input register and one of the plurality of pixel value in the second input register according to the plurality of pixel value in the first input register and the second input register;
a first output register set for receiving the updated pixel values or un-updated pixel values stored in the first input register;
a second output register set for receiving the updated pixel values or un-updated pixel values stored in the second input register; and
a data-transpose multiplexer for selectively executing the data-transpose procedure to the pixel values stored in the first output register set and the second output register set according to a data-transpose signal, and then storing the pixel values, processed by the data-transpose procedure or not processed by the data-transpose procedure, back to the memory buffer.

9. The deblocking-filtering apparatus according to claim 8, wherein the plurality of pixel value stored back to the memory buffer can be further transmitted to a frame buffer.

10. The deblocking-filtering apparatus according to claim 8, wherein each block, having a size of 4×4 bytes, comprises four addresses, a first address is for bits a0˜a3, a second address is for bits b0˜b3, a third address is for bits c0˜c3, and a fourth address is for bits d0˜d3.

11. The deblocking-filtering apparatus according to claim 10, wherein the data-transpose procedure is transposing the first address for bits a0˜d0 to, the second address for bits a1˜d1, the third address for bits a2˜d2, and the fourth address for bits a3˜d3.

12. The deblocking-filtering apparatus according to claim 10, wherein the first input register and the second input register are for reading one address of 4-bit data from the first block of pixel values and the second block of pixel values.

13. The deblocking-filtering apparatus according to claim 8, wherein the macroblock of pixel values includes a plurality of pixel-Y value, a plurality of pixel-U value, or a plurality of pixel-V value.

14. A deblocking-filtering apparatus applied to a video codec, wherein the deblocking-filtering apparatus can receive a plurality of macroblock of pixel values which are sequentially outputted from a motion-compensating unit, and each macroblock of pixel values can be divided into a plurality of block of pixel values, comprising:
a memory buffer at least can be divided to a first memory buffer unit, a second memory buffer unit, a third memory buffer unit, and a fourth memory buffer unit, and each memory buffer unit can sequentially store the macroblock of pixel values, wherein the plurality of block of pixel values stored in the memory buffer units have been processed by a data-transpose procedure; and
a filter module, for executing a deblocking-filtering procedure according to the plurality of macroblock of pixel values stored in the second memory buffer unit and the third memory buffer unit, and then storing the plurality of macroblocks of pixel values, which have been processed by the deblocking-deblocking procedure, back to the first memory buffer unit and the second memory buffer unit;
wherein when the filter module executes the deblocking-filtering procedure to the plurality of macroblock of pixel values stored in the second memory buffer unit and the third memory buffer unit, simultaneously the fourth memory buffer unit receives another macroblock of pixel values, which has been processed by the data-transpose procedure, and simultaneously the first memory buffer unit transmits the macroblock of pixel values, which has been processed by the deblocking-filtering procedure, to a frame buffer.

15. A deblocking-filtering apparatus applied in a video codec according to claim 14, wherein the filter module further comprises:
a first input register for receiving a portion of pixel values in a first block from the second memory buffer unit or the third memory buffer unit;
a second input register for receiving a portion of pixel values in a second block from the second memory buffer unit or the third memory buffer unit;
a filter for updating one of the plurality of pixel value in the first input register and one of the plurality of pixel value in the second input register according to the plurality of pixel value in the first input register and the second input register;
a first output register set for receiving the updated pixel values or un-updated pixel values stored in the first input register;
a second output register set for receiving the updated pixel values or un-updated pixel values stored in the second input register; and
a data-transpose multiplexer for selectively executing or not executing the data-transpose procedure to the pixel values stored in the first output register set and the second output register set according to a data-transpose signal, and then storing the pixel values, processed by the data-transpose procedure or not processed by the data-transpose procedure, back to the memory buffer.

16. The deblocking-filtering apparatus applied in a video codec according to claim 15, wherein the first input register and the second input register are for reading one address of 4-bit data from the first block of pixel values and the second block of pixel values.

17. The deblocking-filtering apparatus applied in a video codec according to claim 14, wherein the block, having a size of 4×4 bytes, comprises four addresses, a first address is for bits a0˜a3, a second address is for bits b0˜b3, a third address is for bits c0˜c3, and a fourth address is for bits d0˜d3.

18. The deblocking-filtering apparatus applied in a video codec according to claim 14, wherein the data-transpose procedure is transposing the first address for bits a0˜d0, the second address for bits a1˜d1, the third address for bits a2˜d2, and the fourth address for bits a3˜d3.

19. The deblocking-filtering apparatus applied in a video codec according to claim 14, wherein the macroblock of pixel values includes a plurality of pixel-Y value, a plurality of pixel-U value, or a plurality of pixel-V value.
